(19) United States
(12) Patent Application Publication
(10) Pub. No.: US 2023/0101097 A1
(43) Pub. Date: Mar. 30, 2023

(54) ARRAY SUBSTRATE, MANUFACTURING METHOD OF ARRAY SUBSTRATE, AND LIQUID CRYSTAL DISPLAY PANEL

(71) Applicant: WUHAN CHINA STAR OPTOELECTRONICS TECHNOLOGY CO., LTD., Wuhan (CN)

(72) Inventor: Zhandong Zhang, Wuhan (CN)

(73) Assignee: WUHAN CHINA STAR OPTOELECTRONICS TECHNOLOGY CO., LTD., Wuhan (CN)

(21) Appl. No.: 17/051,707

(22) PCT Filed: Aug. 28, 2020
(86) PCT No.: PCT/CN2020/112081

§ 371 Date: Oct. 29, 2020

(30) Foreign Application Priority Data
Aug. 19, 2020 (CN) 202010836442.5

(51) Int. Cl. G02F 1/1362; G02F 1/1343; G02F 1/1333; G02F 1/1368

(52) U.S. Cl. CPC G02F 1/136286; G02F 1/134309; G02F 1/133357; G02F 1/136222; G02F 1/1368

(57) ABSTRACT

The present application provides an array substrate, a manufacturing method of the array substrate, and a liquid crystal display panel. The array substrate includes first common wirings disposed in a same layer as gate wirings and formed as discontinuous segments, and second common wirings disposed in a same layer as source/drain wirings. The first common wirings are electrically connected to the second common wirings. More openings are provided between the gate wirings and the first common wirings formed as discontinuous segments for a flow of an etchant, so that the first common wirings and the gate wirings are prevented from being formed too thin or broken due to an accumulation of the etchant.

### FIELD OF INVENTION

The present application is related to the field of display technology, and specifically, to an array substrate, a manufacturing method of the array substrate, and a liquid crystal display panel.

### BACKGROUND OF INVENTION

Currently, liquid crystal displays (LCDs) are one of the most widely used display devices. A working principle of the LCDs is to control deflections of liquid crystal molecules through changes of an electric field formed by pixel electrodes and a common electrode, thereby achieving display effect.

In an LCD, the common electrode is a full-surface covering electrode, which receives a voltage signal at an edge region or non-display region of the LCD, and transmits it to an entire display surface. Because of an impedance of the common electrode, the voltage signal incurs losses in a process of transmitting on the common electrode, resulting in uneven voltage distribution, which affects uniformity of display. This problem is particularly prominent in display of large-size LCDs.

In the prior art, a method to solve this problem is to arrange common wirings parallel to gate wirings on a gate wiring layer of the LCD, and electrically connect the common wirings to the common electrode. A region near a middle of the common electrode is supplied with a voltage to ensure that the voltage is evenly distributed on the common electrode. However, the gate wirings and the common wirings, which are arranged in a same layer and parallel to each other, may have many problems in a manufacturing process. As shown in FIG. 1, a gate wiring 03 disposed on a substrate 01 and a common wiring 02 are rectangular wirings passing through a display region, and their manufacturing process is depositing metal layer on the substrate 01 and forming the gate wiring 03 and the common wiring 02 by exposing, developing, and etching the metal layer. Because the gate wiring 03 and the common wiring 02 are rectangular wirings, two strips of photoresist 04 are parallelly formed on the metal layer 04 after a development process. After an etching process, an etchant 05 is accumulated between the two strips of photoresist 04 and cannot be instantly removed, causing the etchant 05 to over-etch the metal layer on both sides. As a result, the gate wiring 03 and the common wiring 02 are formed too thin or broken, which seriously affects a product yield.

### SUMMARY OF INVENTION

In the prior art, because gate wirings and common wirings in an array substrate, which are arranged in a same layer, are rectangular wirings, an etchant is prone to be accumulated between the two wirings and cannot be instantly removed when etching the gate wirings and the common wirings. This causes the gate wirings and the common wirings to be over-etched, and causes a problem that the gate wirings and the common wirings are formed too thin or broken.

In order to solve the above technical problems, technical solutions provided by the present application are as follows.

The present application provides an array substrate, including:

an array layer including gate wirings, source/drain wirings disposed on the gate wirings, first common wirings disposed in a same layer as the gate wirings, and second common wirings disposed in a same layer as the source/drain wirings, wherein the second common wirings are electrically connected to the first common wirings, and the first common wirings are discontinuous segments; and

a common electrode disposed on the array layer and electrically connected to the second common wirings.

In the array substrate of the present application, each of the second common wirings is provided with a gap. Two ends of each of the second common wirings on two opposite sides of the gap are electrically connected to a same one of the first common wirings.

In the array substrate of the present application, each of the source/drain wirings and each of the second common wirings intersect at the gap. Each of the source/drain wirings and each of the second common wirings are insulated from each other.

In the array substrate of the present application, the first common wirings, which are discontinuous segments, are arranged along an extension direction of the second common wirings, each of the second common wirings is provided with the gap corresponding to each of the first common wirings. The two ends of each of the second common wirings on the two opposite sides of the gap are electrically connected to the same one of the first common wirings.

In the array substrate of the present application, two opposite sides of the array substrate are provided with common wiring ends. Two opposite ends of each of the second common wirings are connected to the common wiring ends.

In the array substrate of the present application, the first common wirings are parallel to the gate wirings.

In the array substrate of the present application, the array substrate further includes pixel electrodes on the common electrode. The pixel electrodes are electrically connected to the source/drain wirings.

In the array substrate of the present application, the array layer is disposed on a base substrate. The array layer includes an active layer disposed on the base substrate, a gate insulating layer covering the active layer, the gate wirings and the first common wirings disposed on the gate insulating layer, an interlayer insulating layer covering the gate wirings and the first common wirings, and the source/drain wirings and the second common wirings disposed on the interlayer insulating layer.

In the array substrate of the present application, the second common wirings are electrically connected to the first common wirings through via-holes in the interlayer insulating layer. The source/drain wirings are electrically connected to the active layer through via-holes in the gate insulating layer and the interlayer insulating layer.

In the array substrate of the present application, a planarization layer is provided between the array layer and the common electrode. The common electrode is electrically connected to the second common wirings through via-holes in the planarization layer.

In the array substrate of the present application, a passivation layer is provided between the common electrode and the pixel electrodes. The pixel electrodes are electrically connected to the source/drain wirings through via-holes in the passivation layer and the planarization layer.

In the array substrate of the present application, the base substrate is provided with a light-shielding layer corresponding to the active layer for shielding light irradiated to the active layer.

The present application further provides a manufacturing method of an array substrate, including steps of:

forming first common wirings and gate wirings in a same layer, wherein the first common wirings are formed as discontinuous segments;

forming second common wirings and source/drain wirings in a same layer on the first common wirings and the gate wirings, wherein the second common wirings are electrically connected to the first common wirings; and

forming a common electrode on the second common wirings and the source/drain wirings, wherein the common electrode is electrically connected to the second common wirings.

In the manufacturing method of the array substrate of the present application, forming the first common wirings and the gate wirings includes a step of: forming a first metal layer and patterning the first metal layer to form the first common wirings and the gate wirings.

In the manufacturing method of the array substrate of the present application, forming the second common wirings and the source/drain wirings includes a step of: forming a second metal layer and patterning the second metal layer to form the second common wirings and the source/drain wirings.

In the manufacturing method of the array substrate of the present application, each of the second common wirings is formed with a gap. Two ends of each of the second common wirings on two opposite sides of the gap are electrically connected to a same one of the first common wirings. Each of the source/drain wirings and each of the second common wirings intersect at the gap. Each of the source/drain wirings and each of the second common wirings are insulated from each other.

In the manufacturing method of the array substrate of the present application, the manufacturing method of the array substrate further includes a step of:

forming pixel electrodes on the common electrode, wherein the pixel electrodes are electrically connected to the source/drain wirings.

The present application further provides a liquid crystal display panel, including:

an array substrate includes an array layer and a common electrode, wherein the array layer includes gate wirings, first common wirings disposed in a same layer as the gate wirings, source/drain wirings disposed on the gate wirings, and second common wirings disposed in a same layer as the source/drain wirings, the second common wirings are electrically connected to the first common wirings, the first common wirings are discontinuous segments, and the common electrode is electrically connected to the second common wirings;

a color filter substrate corresponding to the array substrate; and

a liquid crystal layer disposed between the array substrate and the color filter substrate.

In the liquid crystal display panel of the present application, each of the second common wirings is provided with a gap. Two ends of each of the second common wirings on two opposite sides of the gap are electrically connected to a same one of the first common wirings.

In the liquid crystal display panel of the present application, each of the source/drain wirings and each of the second common wirings intersect at the gap. Each of the source/drain wirings and each of the second common wirings are insulated from each other.

Two opposite sides of the array substrate are provided with common wiring ends. Two opposite ends of each of the second common wirings are connected to the common wiring ends.

In the array substrate, the manufacturing method of the array substrate, and the liquid crystal display panel, the first common wirings in the same layer as the gate wirings are formed as discontinuous segments, and are electrically connected to the second common wirings, so as to supply a voltage to the common electrode to ensure that the voltage is evenly distributed on the common electrode. Meanwhile, more openings are provided between the gate wirings and the first common wirings formed as discontinuous segments for a flow of the etchant, so that the etchant is easier to be removed after an etching process, and the first common wirings and the gate wirings are prevented from being formed too thin or broken due to an accumulation of the etchant.

### DESCRIPTION OF DRAWINGS

In order to describe technical solutions in the present application clearly, drawings to be used in the description of embodiments will be described briefly below. Obviously, drawings described below are only for some embodiments of the present application, and other drawings can be obtained by those skilled in the art based on these drawings without creative efforts.

FIG. 1 is a schematic diagram of an etchant accumulated between a common wiring and a gate wiring during manufacturing of an array substrate in the prior art.

FIG. 2 is a schematic diagram of a planar structure of an array substrate provided by an embodiment of the present application.

FIG. 3 is a cross-sectional schematic diagram of the array substrate provided by an embodiment of the present application.

FIG. 4 is a flowchart of a manufacturing method of the array substrate provided by an embodiment of the present application.

FIG. 5 is a schematic diagram of a structure after a first metal layer is formed in the manufacturing method of the array substrate provided by an embodiment of the present application.

FIG. 6 is a schematic diagram of a structure after the first metal layer is patterned in the manufacturing method of the array substrate provided by an embodiment of the present application.

FIG. 7 is a schematic diagram of a structure after a second metal layer is formed in the manufacturing method of the array substrate provided by an embodiment of the present application.

FIG. 8 is a schematic diagram of a structure after the second metal layer is patterned in the manufacturing method of the array substrate provided by an embodiment of the present application.

FIG. 9 is a schematic diagram of the array substrate obtained by the manufacturing method of the array substrate provided by an embodiment of the present application.

FIG. 10 is a schematic diagram of a liquid crystal display panel provided by an embodiment of the present application.

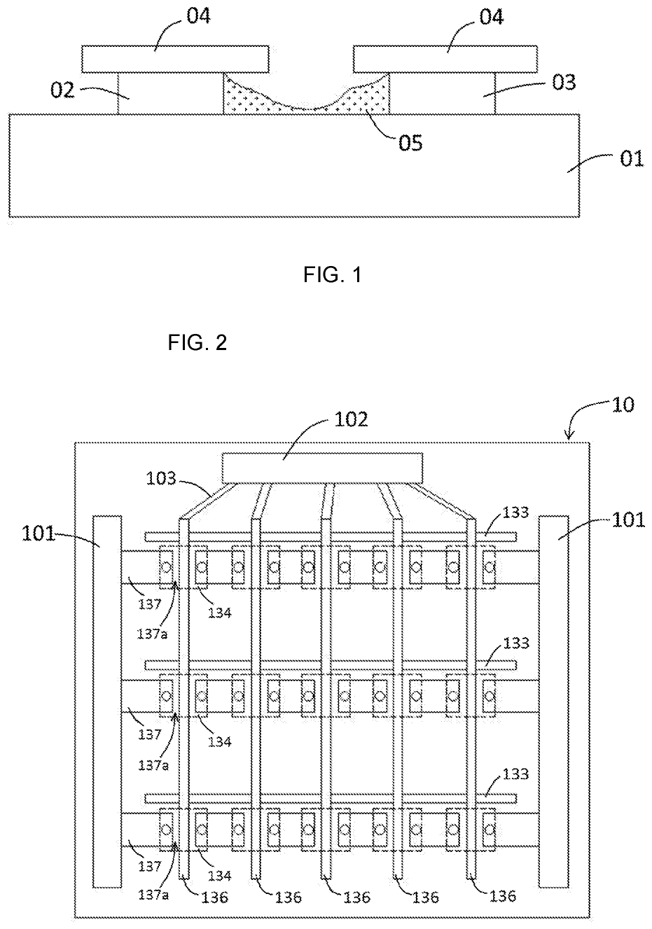

### DETAILED DESCRIPTION OF PREFERRED EMBODIMENTS

Examples are described below with reference to the appended drawings, and the drawings illustrate particular embodiments in which the present application may be practiced. Directional terms mentioned in the present application, such as upper, lower, front, rear, left, right, in, out, side, etc., only refer to directions in the accompanying drawings. Thus, the adoption of directional terms is used to describe and understand the present application, but not to limit the present application. In the drawings, units of similar structures are using the same numeral to represent.

The present application provides an array substrate. The array substrate includes first common wirings disposed in a same layer as gate wirings and are discontinuous segments, and second common wirings disposed in a same layer as source/drain wirings. The first common wirings and the second common wirings are configured to supply voltages to a common electrode. More openings are provided between the gate wirings and the first common wirings formed as discontinuous segments for a flow of an etchant, so that the etchant between the first common wirings and the gate wirings is easier to be removed after an etching process is completed, and the first common wirings and the gate wirings are prevented from being formed too thin or broken due to an accumulation of the etchant.

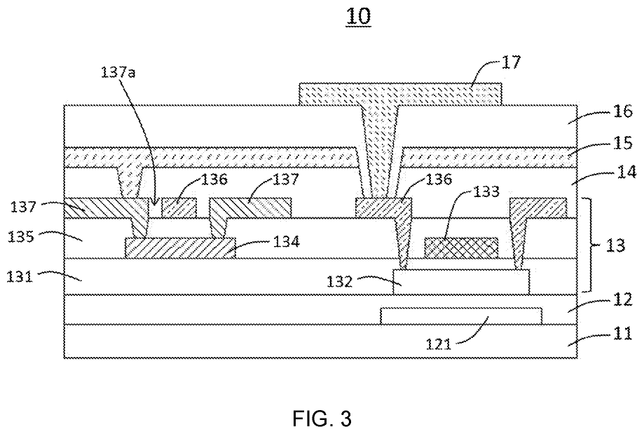

Please refer to FIGS. 2 and 3, FIG. 2 is a schematic diagram of a planar structure of an array substrate provided by an embodiment of the present application, and FIG. 3 is a cross-sectional schematic diagram of the array substrate provided by an embodiment of the present application. The array substrate 10 includes an array layer 13 and a common electrode 15 disposed on the array layer 15. Optionally, the array substrate 10 can further include a base substrate 11, a buffer layer 12 disposed on the base substrate 11, a planarization layer 14 disposed between the array layer 13 and the common electrode 15, a passivation layer 16 disposed on the common electrode 15, and pixel electrodes 17 disposed on the passivation layer 16.

It should be explained that, in the present application, a description of “an element is disposed on another element” is only used to illustrate a relative positional relationship between the two elements. There can be provided with other elements between the two elements, or can be provided with no other elements between them.

The base substrate 11 can be a rigid substrate or a flexible substrate. The base substrate 11 can be made of rigid materials such as glasses when it is configured as the rigid substrate, and the base substrate 11 can be made of flexible materials such as polyimide when it is configured as the flexible substrate.

The buffer layer 12 is disposed on the base substrate 11 for balancing a performance difference between the base substrate 11 and the array layer 13. A side of the buffer layer 12 adjacent to the base substrate 11 or the array layer 13 is provided with a light-shielding layer 121 for shielding light irradiated to an active layer 132 in the array layer 13.

The array layer 13 includes gate wirings 133 and source/drain wirings 136 disposed on the gate wirings 133. The array layer 13 further includes first common wirings 134 disposed in a same layer as the gate wirings 133, and second common wirings 137 disposed in a same layer as the source/drain wirings 136. Optionally, the array layer 13 can further include the active layer 132, a gate insulating layer 131, and an interlayer insulating layer 135. The active layer 132 is disposed on the buffer layer 12. The active layer 132 is made of semiconductor materials such as metal-oxide semiconductors or low-temperature-polysilicon semiconductors. Two ends of the active layer 132 are respectively formed with a source and a drain through an ion doping process. A middle region of the active layer 132 is formed with a channel region connected to the source and the drain. The gate insulating layer 131 is disposed on the buffer and covers the active layer 132. The gate insulating layer 131 can be made of ceramic materials such as silicon nitride and silicon oxide. The gate wirings 133 and the first common wirings are disposed on the gate insulating layer 131. The interlayer insulating layer 135 is disposed on the gate insulating layer 131 and covers the gate wirings 133 and the first common wirings 134. The interlayer insulating layer 135 can be made of ceramic materials such as silicon nitride and silicon oxide. The source/drain wirings 136 and the second common wirings 137 are disposed on the interlayer insulating layer 135. The source/drain wirings 136 are electrically connected to the source and the drain of the active layer 132 through the interlayer insulating layer 135 and via-holes in the gate insulating layer 131. The second common wirings 137 are electrically connected to the first common wirings 134 through via-holes in the interlayer insulating layer 135.

A shown in FIG. 2, the first common wirings 134 are discontinuous segments. In a direction of an extension direction of the gate wirings 133, the first common wirings 134, which are discontinuous segments, are arranged parallel to each other. Optionally, the first common wirings 134, which are arranged parallel to each other, are parallel to the gate wirings 133. It should be explained that, in this embodiment, the first common wirings 134 arranged parallel to the gate wirings 133 are all discontinuous segments, and an opening region is formed between two adjacent first common wirings 134. During an etching process of forming the first common wirings 134 and the gate wirings 133, an etchant is easier to be removed through the opening region, which prevents a problem of forming too thin or broken first common wirings 134 and the gate wirings 133 due to the etchant between them being difficult to be removed in a short time.

As shown in FIGS. 2 and 3, the second common wirings 137 are stacked on the first common wirings 134. The first common wirings 134, which are discontinuous segments, are arranged along an extension direction of the second common wirings 137. Each of the second common wirings 137 is provided with a gap 137a corresponding to each of the first common wirings 134. Two ends of each of the second common wirings 137 on two opposite sides of the gap 137a are electrically connected to a same one of the first common wirings 134, so as to electrically connect the second common wirings 137 on the two opposite sides of the gap 137a, and form a bridge structure to connect the first common wirings 134 and the second common wirings 137.

Furthermore, each of the source/drain wirings 136 and each of the second common wirings 137 intersect at the gap 137a. Each of the source/drain wirings 136 and each of the second common wirings 137 are not electrically connected to each other, so as to form a wiring structure that each of the second common wirings 137 and each of the source/drain wirings 136 are insulated from each other. Optionally, each of the source/drain wirings 136 and each of the second common wirings 137 are arranged perpendicular to each other, and an intersection point of them is positioned at the gap 137a. It should be explained that the gate wirings 133 and the source/drain wirings 136 enclose a plurality of grid regions on the array substrate 10, and each of the grid regions corresponds to a subpixel region on the array substrate 10.

As shown in FIG. 2, two opposite sides of the array substrate 10 are provided with common wiring ends 101. Two opposite ends of each of the second common wirings 137 are connected to the common wiring ends 101 on the two opposite sides of the array substrate 10. It should be explained that the common wiring ends 101 are configured to transmit a common voltage signal to the second common wirings 137. Under an electrical connection of the first common wirings 134, the common voltage signal is transmitted on an entire one of each of the second common wirings 137, and further transmitted to the common electrode 15 (refer to FIGS. 2 and 3) to ensure that the voltage is evenly distributed on the common electrode 15.

A side of the array substrate 10 is provided with a data signal control end 102. The data signal control end 102 is electrically connected to the source/drain wirings 136 through fanout wirings 103, and is configured to transmit a data signal to the source/drain wirings 136. The data signal is further transmitted to the pixel electrodes 17 (refer to FIGS. 2 and 3) to adjust a voltage state of the pixel electrodes 17.

As shown in FIG. 3, the common electrode 15 is electrically connected to the second common wirings 137 through via-holes in the planarization layer 14, so as to ensure that the common voltage signal in the second common wirings 137 can be transmitted to the common electrode 15. Optionally, there can be provided with a plurality of connection points between each of the second common wirings 137 and the common electrode 15, so that the common voltage signal transmitted by the second common wirings 137 is evenly distributed on the common electrode 15, thereby ensuring that the voltage is evenly distributed on the common electrode 15.

The pixel electrodes 17 are electrically connected to the source/drain wirings 136 through via-holes in the passivation layer 16 and the planarization layer 14. The pixel electrodes 17 are electrically insulated from the common electrode 15, and the pixel electrodes 17 receive the data signal transmitted by the source/drain wirings 136 to generate electric fields. It should be explained that when the array substrate 10 is applied to a liquid crystal display panel, the common electrode 15 and the pixel electrodes 17 respectively generate electric fields, and liquid crystals in the liquid crystal display panel are deflected under an action of the two electric fields to adjust display gray scales, so that the liquid crystal display panel displays different images.

In summary, the array substrate provided by an embodiment of the present application includes the first common wirings disposed in the same layer as the gate wirings and are discontinuous segments, and the second common wirings disposed in the same layer as source/drain wirings. The first common wirings and the second common wirings are configured to supply voltages to the common electrode to ensure that the voltage is evenly distributed on the common electrode. More openings are provided between the gate wirings and the first common wirings formed as discontinuous segments for a flow of the etchant, so that the etchant between the first common wirings and the gate wirings is easier to be removed after the etching process is completed, and the first common wirings and the gate wirings are prevented from being formed too thin or broken due to an accumulation of the etchant.

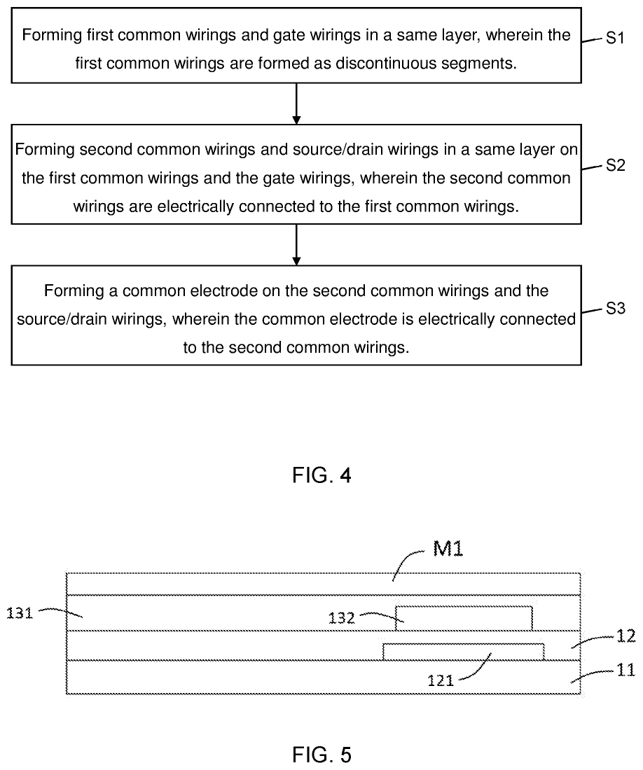

The present application further provides a manufacturing method of an array substrate, as shown in FIG. 4, the manufacturing method of the array substrate includes the following steps.

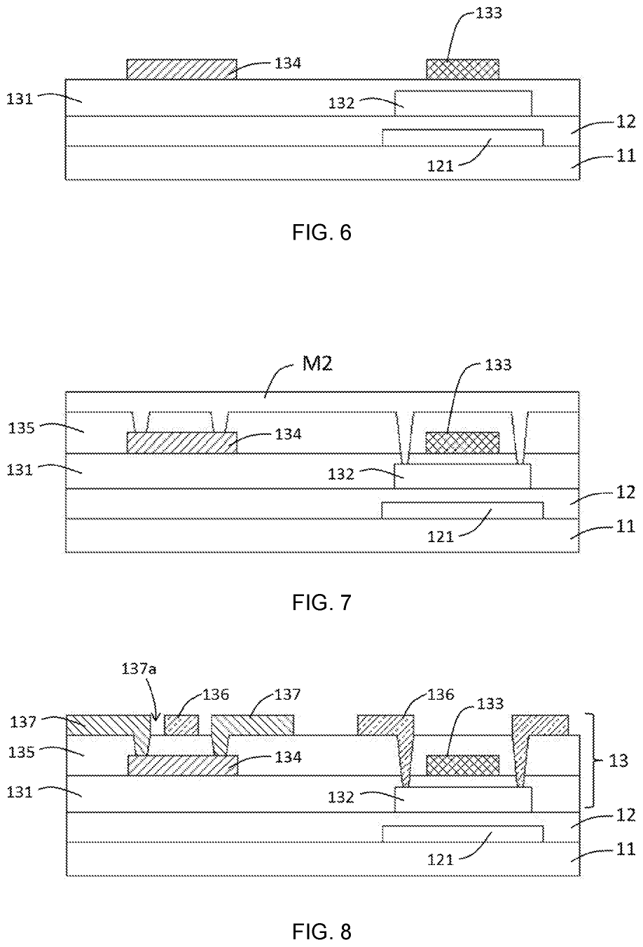

Step S1, as shown in FIG. 6, first common wirings 134 and gate wirings 133 are formed in a same layer, and the first common wirings 134 are formed as discontinuous segments. Step S1 specifically includes the following steps.

A base is provided. Optionally, the base includes a base substrate 11, a light-shielding layer 121 disposed on the base substrate 11, a buffer layer 12 disposed on the base substrate 11 and covering the light-shielding layer 121, an active layer 132 disposed on the buffer layer 12, and a gate insulating layer 131 disposed on the active layer 132. The light-shielding layer 121 is configured to shield light irradiated to the active layer 132.

As shown in FIG. 5, a first metal layer M1 is formed on the base. Optionally, the first metal layer M1 is formed by vapor deposition or spraying.

As shown in FIG. 6, the first metal layer M1 is patterned to form the first common wirings 134 and the gate wirings 133. The first common wirings 134 are formed as discontinuous segments. Optionally, a patterning process of the first metal layer M1 includes coating a photoresist, exposing and developing the photoresist, and patterning and etching the first metal layer M1. It should be explained that because the first common wirings 134 formed in this embodiment are discontinuous segments, an opening region is formed between two adjacent first common wirings 134. After completely etching the first metal layer M1, an etchant is easier to be removed through the opening region, which prevents a problem of forming too thin or broken first common wirings 134 and the gate wirings 133 due to the etchant between them being difficult to be removed in a short time.

Step S2, as shown in FIG. 8, second common wirings 137 and source/drain wirings 136 are formed in a same layer on the first common wirings 134 and the gate wirings 133, so that the second common wirings 137 are electrically connected to first common wirings 134. Step S2 further includes the following steps.

An interlayer insulating layer 135 is formed to cover the first common wirings 134 and the gate wirings 133 before the second common wirings 137 and the source/drain wirings 136 are formed. The interlayer insulating layer 135 can be made of ceramic materials such as silicon nitride and silicon oxide through a chemical vapor deposition process.

As shown in FIG. 7, a second metal layer M2 is formed on the interlayer insulating layer 135. The second metal layer M2 is electrically connected to the first common wirings 134 through via-holes in the interlayer insulating layer 135. Optionally, the second metal layer M12 is formed by vapor deposition or spraying.

As shown in FIG. 8, the second metal layer M2 is patterned to form the second common wirings 137 and the source/drain wirings 136. Optionally, a patterning process of the second metal layer M2 includes coating the photoresist, exposing and developing the photoresist, and patterning and etching the second metal layer M2. Each of the second common wirings 137 is formed with a gap 137a corresponding to each of the first common wirings 134. Two ends of each of the second common wirings 137 on two opposite sides of the gap 137a are electrically connected to a same one of the first common wirings 134, so as to electrically connect the second common wirings 137 on the two opposite sides of the gap 137a, and form a bridge structure to connect the first common wirings 134 and the second common wirings 137. Each of the source/drain wirings 136 and each of the second common wirings 137 intersect at the gap 137a. Each of the second common wirings 137 and each of the source/drain wirings 136 are electrically insulated from each other.

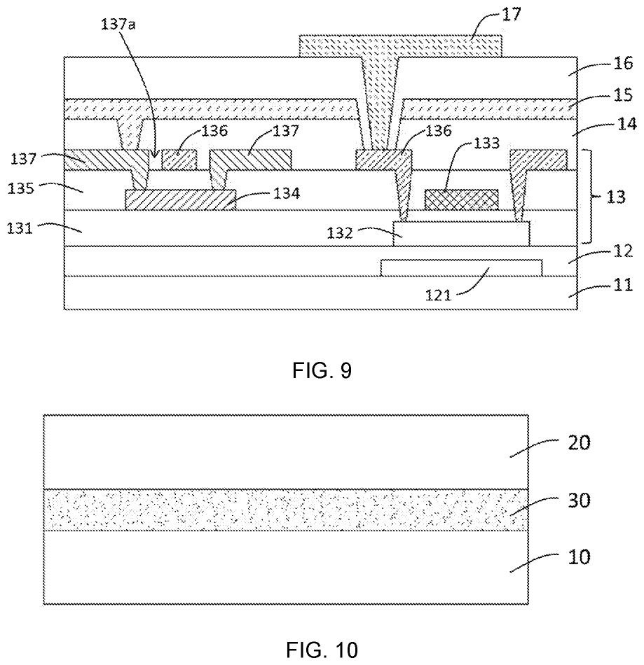

Step S3, as shown in FIG. 9, a common electrode 15 is formed on the second common wirings 137 and the source/drain wirings 136. The common electrode 15 is electrically connected to the second common wirings 137. Specifically, a planarization layer 14 is formed to cover the second common wirings 137 and the source/drain wirings 136 before the common electrode 15 is formed. The common electrode 15 is electrically connected to the second common wirings 137 through via-holes in the planarization layer 14. Understandably, common voltage transmission lines composed of the second common wirings 137 and the first common wirings 134 are configured to transmit a common voltage to the common electrode 15, which is beneficial to evenly distribute a voltage on the common electrode 15.

Optionally, the manufacturing method of the array substrate further includes forming passivation layer 16 on the common electrode 15, and forming pixel electrodes 17 on the common electrode 15. The pixel electrodes 17 are electrically connected to the source/drain wirings 136.

In summary, in the array substrate and the manufacturing method of the array substrate, more openings are provided between the gate wirings and the first common wirings formed as discontinuous segments for a flow of the etchant, so that the etchant between the first common wirings and the gate wirings is easier to be removed after an etching process is completed, the first common wirings and the gate wirings are prevented from being formed too thin or broken due to an accumulation of the etchant, and a production yield of the array substrate is increased.

The present application further provides a liquid crystal display panel, as shown in FIG. 10, the liquid crystal display panel includes an array substrate 10, a color filter substrate 20 corresponding to the array substrate 10, and a liquid crystal layer 30 disposed between the array substrate 10 and the color filter substrate 20. The array substrate 10 is an array substrate provided by an embodiment of the present application or an array substrate obtained by the manufacturing method of the array substrate. It should be explained that the liquid crystal display panel provided by the present application overcomes a problem that the gate wirings and the common wirings are formed too thin or broken due to an accumulation of the etchant, which is beneficial to increase the production yield.

Although the present application has been disclosed above with the preferred embodiments, it is not intended to limit the present application. Persons having ordinary skill in this technical field can still make various alterations and modifications without departing from the scope and spirit of this application. Therefore, the scope of the present application should be defined and protected by the following claims and their equivalents.

What is claimed is:

1. An array substrate, comprising:
an array layer comprising gate wirings, source/drain wirings disposed on the gate wirings, first common wirings disposed in a same layer as the gate wirings, and second common wirings disposed in a same layer as the source/drain wirings, wherein the second common wirings are electrically connected to the first common wirings, and the first common wirings are discontinuous segments; and
a common electrode disposed on the array layer and electrically connected to the second common wirings.

2. The array substrate according to claim 1, wherein each of the second common wirings is provided with a gap, and two ends of each of the second common wirings on two opposite sides of the gap are electrically connected to a same one of the first common wirings.

3. The array substrate according to claim 2, wherein each of the source/drain wirings and each of the second common wirings intersect at the gap, and each of the source/drain wirings and each of the second common wirings are insulated from each other.

4. The array substrate according to claim 2, wherein the first common wirings, which are discontinuous segments, are arranged along an extension direction of the second common wirings, each of the second common wirings is provided with the gap corresponding to each of the first common wirings, and the two ends of each of the second common wirings on the two opposite sides of the gap are electrically connected to the same one of the first common wirings.

5. The array substrate according to claim 1, wherein two opposite sides of the array substrate are provided with common wiring ends, and two opposite ends of each of the second common wirings are connected to the common wiring ends.

6. The array substrate according to claim 1, wherein the first common wirings are parallel to the gate wirings.

7. The array substrate according to claim 1, further comprising pixel electrodes on the common electrode, wherein the pixel electrodes are electrically connected to the source/drain wirings.

8. The array substrate according to claim 7, wherein the array layer is disposed on a base substrate; and
the array layer comprises an active layer disposed on the base substrate, a gate insulating layer covering the active layer, the gate wirings and the first common wirings disposed on the gate insulating layer, an interlayer insulating layer covering the gate wirings and the first common wirings, and the source/drain wirings and the second common wirings disposed on the interlayer insulating layer.

9. The array substrate according to claim 8, wherein the second common wirings are electrically connected to the first common wirings through via-holes in the interlayer insulating layer, and the source/drain wirings are electrically connected to the active layer through via-holes in the gate insulating layer and the interlayer insulating layer.

10. The array substrate according to claim 8, wherein a planarization layer is provided between the array layer and the common electrode, and the common electrode is electrically connected to the second common wirings through via-holes in the planarization layer.

11. The array substrate according to claim 10, wherein a passivation layer is provided between the common electrode and the pixel electrodes, and the pixel electrodes are electrically connected to the source/drain wirings through via-holes in the passivation layer and the planarization layer.

12. The array substrate according to claim 8, wherein the base substrate is provided with a light-shielding layer corresponding to the active layer for shielding light irradiated to the active layer.

13. A manufacturing method of an array substrate, comprising steps of:
forming first common wirings and gate wirings in a same layer, wherein the first common wirings are formed as discontinuous segments;
forming second common wirings and source/drain wirings in a same layer on the first common wirings and the gate wirings, wherein the second common wirings are electrically connected to the first common wirings; and
forming a common electrode on the second common wirings and the source/drain wirings, wherein the common electrode is electrically connected to the second common wirings.

14. The manufacturing method of the array substrate according to claim 13, wherein forming the first common wirings and the gate wirings comprises a step of:
forming a first metal layer and patterning the first metal layer to form the first common wirings and the gate wirings.

15. The manufacturing method of the array substrate according to claim 13, wherein forming the second common wirings and the source/drain wirings comprises a step of:
forming a second metal layer and patterning the second metal layer to form the second common wirings and the source/drain wirings.

16. The manufacturing method of the array substrate according to claim 13, wherein each of the second common wirings is formed with a gap, two ends of each of the second common wirings on two opposite sides of the gap are electrically connected to a same one of the first common wirings; and
each of the source/drain wirings and each of the second common wirings intersect at the gap, and each of the source/drain wirings and each of the second common wirings are insulated from each other.

17. The manufacturing method of the array substrate according to claim 13, further comprising a step of:
forming pixel electrodes on the common electrode, wherein the pixel electrodes are electrically connected to the source/drain wirings.

18. A liquid crystal display panel, comprising:
an array substrate comprising an array layer and a common electrode, wherein the array layer comprises gate wirings, first common wirings disposed in a same layer as the gate wirings, source/drain wirings disposed on the gate wirings, and second common wirings disposed in a same layer as the source/drain wirings, the second common wirings are electrically connected to the first common wirings, the first common wirings are discontinuous segments, and the common electrode is electrically connected to the second common wirings;
a color filter substrate corresponding to the array substrate; and
a liquid crystal layer disposed between the array substrate and the color filter substrate.

19. The liquid crystal display panel according to claim 18, wherein each of the second common wirings is provided with a gap, and two ends of each of the second common wirings on two opposite sides of the gap are electrically connected to a same one of the first common wirings.

20. The liquid crystal display panel according to claim 19, wherein each of the source/drain wirings and each of the second common wirings intersect at the gap, and each of the source/drain wirings and each of the second common wirings are insulated from each other; and
two opposite sides of the array substrate are provided with common wiring ends, and two opposite ends of each of the second common wirings are connected to the common wiring ends.
